(19) United States
(12) Patent Application Publication
(10) Pub. No.: US 2014/0297507 A1
(43) Pub. Date: Oct. 2, 2014

(54) METHOD, DEVICE AND SYSTEM FOR COLLABORATIVE ORDER

(71) Applicant: Tencent Technology (Shenzhen) Company Limited, Shenzhen City (CN)

(72) Inventors: Zhengrong Wang, Shenzhen City (CN); Yuan Guo, Shenzhen City (CN); Xuan Zhang, Shenzhen City (CN); Tianyu Du, Shenzhen City (CN); Yundong Huang, Shenzhen City (CN); Fang Yu, Shenzhen City (CN); Siyuan Shen, Shenzhen City (CN)

(73) Assignee: Tencent Technology (Shenzhen) Company Limited, Shenzhen City (CN)

(21) Appl. No.: 14/280,265

(22) Filed: May 16, 2014

Related U.S. Application Data
(63) Continuation of application No. PCT/CN2013/088314, filed on Dec. 2, 2013.

(30) Foreign Application Priority Data
Mar. 28, 2013 (CN) 201310105464.4

(51) Int. Cl. G06Q 40/04

(52) U.S. Cl. CPC G06Q 40/04
USPC 705/37

(57) ABSTRACT

A method and system for collaborative order are provided. The method may include receiving a collaborative order request, containing commodity information, sent by a subscriber. A related user of the subscriber may be identified from a set of users related to the subscriber. A collaborative order invitation for the commodity may be sent to the related user to invite the related user to send sub-order information for the commodity. Order information for the commodity sent by the subscriber and sub-order information for the commodity sent by the related user may be received and combined, to obtain combined order information. The combined order information may be sent to a trading platform for processing trade of the commodity by processing the combined order information.

This application is a continuation of International application PCT/CN2013/088314, filed on Dec. 02, 2013 which claims the priority to Chinese Patent Application No. 201310105464.4, entitled “METHOD, DEVICE AND SYSTEM FOR COLLABORATIVE ORDER”, filed with the Chinese State Intellectual Property Office on Mar. 28, 2013, which are incorporated by reference in their entirety herein.

### FIELD

The present disclosure relates to the field of internet technology, and in particular, to a method, device and system for placing and processing a collaborative order.

### BACKGROUND

Generally, trading a commodity over the internet, via a business-to-consumer (B2C) or a consumer-to-consumer (C2C) trading platform involves placing an order for the commodity. The order may be placed by a subscriber via a subscriber terminal. The subscriber may share information related to the commodity, such as details of the commodity or a webpage link of the commodity, with users related to the subscriber. The related users may place orders for the commodity, independently. Generally, an order placed by the subscriber and a user related to the subscriber are independent from each other. The trading platform may, in turn, process the orders one by one, thereby reducing the efficiency of the trading platform. In addition, contents such as the commodity information shared by the subscriber are not designed to be sent to targeted users, which results in a low hit rate, and the purchasing result of the targeted users is not fed back immediately.

### SUMMARY

A method, a device and a system for collaborative order are provided by embodiments of the present disclosure, by which collaborative order can be achieved. A collaborative order increases the processing efficiency of a trading platform, and further enables sending contents, such as the commodity information shared by a subscriber, to targeted users.

In a first aspect, a method for collaborative order is provided. The method may include the following steps.

The method may include receiving a collaborative order request sent by a subscriber. The collaborative order request may carry commodity information. The commodity information may identify a commodity being traded on an online trading platform.

The method may further include acquiring or determining identity of a user related to the subscriber. The related user may be identified from a set of users related to the subscriber in response to the collaborative order request.

The method may continue by sending a collaborative order invitation of the commodity information to the related user of the subscriber. The invitation may invite the related user of the subscriber to send sub-order information of the commodity information. The collaborative order invitation may be sent to more than one related user.

Further, the method may involve receiving order information of the commodity information sent by the subscriber and the sub-order information of the commodity information sent by the related user of the subscriber. The sub-order information may be received from more than one related user. The order information and the sub-order information may be combined to obtain combined order information.

The combined order information may be sent to the trading platform for processing the order from the subscriber and the sub-order form the related user(s).

In a second respect, a device for collaborative order is provided. The device may include a receiving unit, an acquisition unit, a sending unit and a combining unit.

The receiving unit may receive a collaborative order request sent by a subscriber. The collaborative order request carries commodity information.

The acquisition unit may acquire a related user from a related user set of the subscriber in response to the collaborative order request. The related user set may comprise identities or contact information of users related to the subscriber. The acquisition unit may acquire more than one related user from the related user set.

The sending unit may send a collaborative order invitation of the commodity information to the related user of the subscriber, to invite the related user to send sub-order information of the commodity information.

The combining unit may receive order information of the commodity information sent by the subscriber. The combining unit may further receive the sub-order information of the commodity information sent by the related user of the subscriber. The combining unit may then combine the order information sent by the subscriber and the sub-order information sent by the related user to obtain combined order information.

The sending unit may send the combined order information to a trading platform of the commodity information. The trading platform may process the combined order information to realize the order placed by the subscriber and the sub-order placed by the related user.

In a third aspect, a system for collaborative order is provided. The system may include a subscriber terminal, an instant messenger server, a relational user terminal, a combining and processing platform and a trading platform.

The subscriber terminal may receive a collaborative order request input by a subscriber. The subscriber terminal may send the collaborative order request to the instant messenger server. The collaborative order request may include commodity information.

The instant messenger server may receive the collaborative order request sent by the subscriber terminal. In response to the collaborative order request, the instant messenger server may determine a related user terminal. The related user terminal may be a terminal corresponding to related user of the subscriber. The related user may be identified from a set of users related to the subscriber. The instant messenger server may further send a collaborative order invitation of the commodity information to the related user terminal corresponding to the related user of the subscriber.

The related user terminal may send sub-order information of the commodity information to the combining and processing platform in response to the collaborative order invitation.

The subscriber terminal may further receive order information of the commodity information input by the subscriber and send the order information to the combining and processing platform.

The combining and processing platform may receive the order information of the commodity information sent by the subscriber terminal. The combining and processing platform may further receive the sub-order information of the commodity information sent by the related user terminal. The combining and processing platform may combine the order information and the sub-order information to obtain combined order information, and send the combined order information to the trading platform.

The trading platform may receive the combined order information. The trading platform may process the order and the sub-order from the subscriber and the related user respectively, based on the order information and the sub-order information contained in the combined order information.

With the method, device and system for collaborative order described by the present disclosure, a collaborative order for a commodity being traded via an online trading platform may be realized. The collaborative order may reduce the number of the orders to be processed on the trading platform and in turn, may increase the processing efficiency of the trading platform. Further, contents such as the commodity information that may be shared by a subscriber may be sent to targeted users.

### BRIEF DESCRIPTION OF THE DRAWINGS

In order to clearly describe the technical solutions in the embodiments of the present disclosure, drawings to be used in the embodiments will be described briefly in the following. Obviously, the drawings described below are only some embodiments of the present disclosure, and other drawings may be obtained by those skilled in the art based on these drawings without any creative work.

FIG. 1 illustrates a flowchart of an example method for a collaborative order provided by an embodiment of the present disclosure;

FIG. 2 illustrates a flowchart of another example method for collaborative order provided by an embodiment of the present disclosure;

FIG. 3 illustrates a structure diagram of an example device for collaborative order provided by an embodiment of the present disclosure;

FIG. 4 illustrates a structure diagram of another example device for collaborative order provided by an embodiment of the present disclosure; and

FIG. 5 illustrates a structure diagram of an example system for collaborative order provided by an embodiment of the present disclosure.

### DETAILED DESCRIPTION

The discussion below makes reference to the accompanying drawings which show, by way of illustration, specific embodiments, described in this document, may be practiced. Other embodiments may be utilized and structural changes may be made without departing from the scope of the present document. The described embodiments are only some of the possible embodiments of the present disclosure. Based on the embodiments of the present disclosure, all the other embodiments obtained by those skilled in the art without any creative work shall fall into the scope of protection of the disclosure.

A method and a system for collaborative order are provided according to the embodiments of the present disclosure. Using the described embodiments, a collaborative order can be realized and the processing efficiency of the trading platform can be increased. The method and system are described below in details.

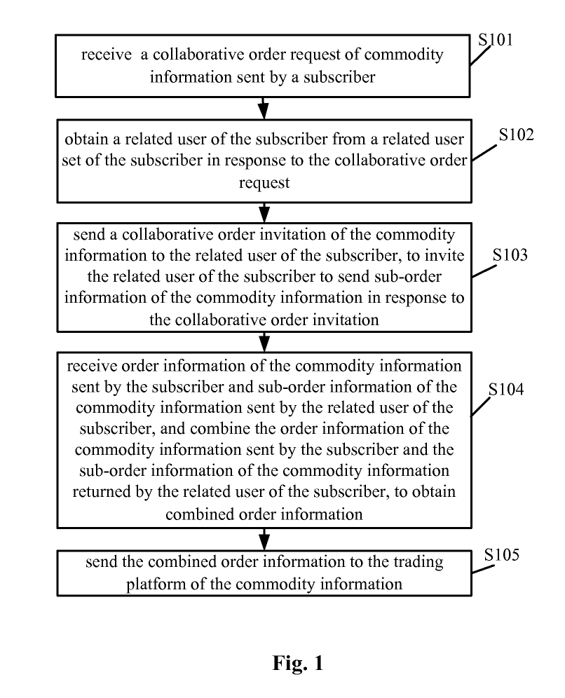

FIG. 1 illustrates a flowchart of an example method for collaborative order provided by an embodiment of the present disclosure. As shown in FIG. 1, the method for collaborative order may include the following steps.

Step S101 may involve receiving a collaborative order request sent by a subscriber. The collaborative order request may carry commodity information.

The subscriber may be a subscriber of an online service such as a trading platform, a social networking platform, a messaging platform or any other online service platform. The trading platform may be, for example, a platform which provides commodities for ordering. The social networking platform or the messaging platform may be, for example, a platform which includes sharing information about commodities for ordering or an entry for the commodities for ordering. For example, the subscriber may place an order for a commodity via a trading platform. For another example, the subscriber may place an order for a commodity via a social networking platform by sharing information of commodities. The description is not limited thereto.

The commodity information may be commodity information recommended to the subscriber by a system and adopted by the subscriber.

In one embodiment, the commodity information may be order information of the commodity. After the subscriber opens a webpage with the commodity details and places an order, the system may receive a collaborative order request including order information of the commodity information sent by the subscriber. The order information of the commodity may include, for example, quantity of ordered commodities, delivery address, delivery time and contact information of the subscriber. The order information may also provide identity of the commodity and a network link to the commodity webpage.

Step S102 may be performed in response to the collaborative order request. Step 102 may involve obtaining identity of a user related to, or associated with the subscriber from a set of users related, or associated with the subscriber.

The related user of the subscriber may include, for example, a friend user of the subscriber, such as a user listed in a contact list of the subscriber. For example, the contact list may be an address book in an electronic communication medium used by the subscriber, such as in an in an instant messenger tool the subscriber logs in to (such as WeChat, Viber, MSN messenger), or a social networking platform that the subscriber uses. Additionally, or alternatively, the related user may be a network user associated with the subscriber, such as a visitor of a personal space the subscriber logs in to, or an audience of a microblog (such as Twitter, Weibo, Baidu Talk) the subscriber logs in to. Further yet, the related user may be a ‘follower’ user who customizes his/her preferences to follow the commodity information on the trading platform, or a user who has ordered another commodity on the trading platform.

The trading platform may include, for example, an electronic shop and an electronic sales platform. The trading platform may be a business-to-consumer, a consumer-to-consumer trading platform or a combination of both. Common examples of such trading platforms include Amazon, eBay, DangDang.

After receiving the commodity information sent by the subscriber, the system may implement the above-mentioned Step S102 which may further involve the following Steps 1) to Step 4).

Step1) may involve selecting one, some, or all of related users of the subscriber from a related user set of the subscriber.

Step2) may involve generating a related user list based on the selected related users of the subscriber.

Step3) may involve sending the related user list to the subscriber.

Step4) may involve receiving, from the subscriber, a related user of the subscriber selected by the subscriber from the related user list.

The system may receive part or all of the related users of the subscriber in the related user list as those selected and sent by the subscriber. That is, by Step1) to Step4), the subscriber may select independently and accurately the related user expected by the subscriber to participate in the collaborative order. Therefore, the contents such as commodity information shared by the subscriber may be sent to targeted users. Thus, the participating users of the collaborative order may be controlled accurately. Further, the order privacy may be protected effectively.

For example, after the system receives commodity information sent by a subscriber, the system may detect that the subscriber has logged in to an instant messenger tool successfully. The system may analyze the set of users related to the subscriber based on the list of users in a contact list of the instant messenger tool. The set of users in the instant messenger tool may be used as a related user set. The system may select one, some, or all of the users in the related user set. The system may further generate a related user list corresponding to the subscriber as shown in Table 1 based on the selected users related to the subscriber.

TABLE 1
Related user list of subscriber
Friend user 1
Friend user 2
Friend user 3
.
.
.
Friend user N

The system may send the related user list as shown in Table 1 to the subscriber. The subscriber may further select a part or all of the users from the related user list. The subscriber may send the selected users to the system. For example, the subscriber may tick friend user 1, friend user 2 and friend user 3 in the related user list shown in Table 1. The subscriber may then send the related user list with the friend user 1, friend user 2 and friend user 3 ticked to the system. After receiving the related user list of the subscriber with the friend user 1, friend user 2 and friend user 3 ticked, the system may identify that the subscriber independently selected the friend user 1, friend user 2 and friend 3 as those expected to participate in the collaborative order.

In another example, after receiving commodity information sent by the subscriber, the system may detect that there are follower users following the commodity information on the trading platform of the commodity information. A follower user may have customized an online service, such as Twitter, or Pinterest, or other such services to track the information related to the commodity. Alternatively, the trading platform may provide such tracking service to a user. The system may analyze the related user set of the subscriber, and select one or more of the follower users following the commodity information in the related user set. The system may generate a related user list corresponding to the subscriber as shown in Table 2 based on the selected follower users following the commodity information.

TABLE 2
Related user list of subscriber
Follow user 1
Follow user 2
Follow user 3
.
.
.
Follow user N

The system may send the related user list corresponding to the subscriber as shown in Table 2 to the subscriber. The subscriber may select part or all of the follower users from the related user list as shown in Table 2. The subscriber may send indication of the selection of the follower users to the system. For example, the subscriber may tick follow user 1 and follow user 2 in the related user list shown in Table 2, and send the related user list with the follow user 1 and follow user 2 ticked to the system. After receiving the related user list with the follow user 1 and follow user 2 selected, the system may identify that the subscriber independently selected the follower 1 and follower 2 as those expected to participate in the collaborative order.

In yet another example, after receiving order information of the commodity sent by a subscriber, the system may detect that the subscriber has logged in to an instant messenger tool successfully. The system may further detect that there are follower users who are following the commodity information on the trading platform of the commodity information. The system may analyze the related user set of the subscriber from the instant messenger tool, and select some or all of friend users in the related user set. The system may further select some or all of the follower users who are following the commodity information and are in the related user set. The system may further generate a related user list, such as as shown in Table 3, based on the selected friend users in the related user set and the selected follower users who are following the commodity information and are in the related user set.

TABLE 3
Related user list of subscriber
Friend user 1
Friend user 2
Friend user 3
.
.
.
Friend user N
Follow user N + 1
Follow user N + 2
Follow user N + 3
.
.
.

The system may send the related user list of the subscriber as shown in Table 3 to the subscriber. The subscriber may select some or all of the friend users and/or some or all of the follow users from the related user list of the subscriber shown in Table 3. The selected friend users and/or the follow users may be sent to the system. For example, the subscriber may tick friend user 1, friend user 3, follow user N+1 and follow user N+2 in the related user list of the subscriber shown in Table 3, and send the related user list of the subscriber, with the selection of friend user 1, friend user 3, follow user N+1 and follow user N+2, to the system. After receiving the related user list of the subscriber with the selections of friend user 1, friend user 3, follow user N+1 and follow user N+2, the system may identify that the subscriber independently selected the friend user 1, friend user 3, follow user N+1 and follow user N+2 as those expected to participate in the collaborative order.

Step S103 may involve sending a collaborative order invitation of the commodity information to a related user of the subscriber, to invite the related user to send sub-order information of the commodity information in response to the collaborative order invitation.

The collaborative order invitation of the commodity information sent by the system to the related user of the subscriber may carry detailed information and webpage link information of the commodity information. After the related user of the subscriber receives the collaborative order invitation of the commodity information carrying the detailed information and webpage link information, the related user may accept the collaborative order invitation of the commodity information. The related user may, in response to the collaborative order invitation, send sub-order information of the commodity information to the system. Alternatively, in case the related user does not accept the collaborative order invitation of the commodity information, the related user may, in response to the collaborative order invitation, send a response refusing the collaborative order to the system.

The sub-order information from the related user may be an order placed by the related user to trade the commodity via the trading platform. The sub-order information of the commodity information may include, for example, quantity of ordered commodities, delivery address, delivery time and contact information of the related user.

Step S104 may involve receiving the order information of the commodity information sent by the subscriber and the sub-order information of the commodity information sent by the related user, and combining the order information and the sub-order information, to obtain combined order information.

In Step S105, the combined order information may be sent to the trading platform of the commodity information for further processing.

After receiving the combined order information, the trading platform may arrange for the production and delivery of the commodity based on the order information and the sub-order information from the subscriber and the related users respectively.

Thus, the example method described in FIG. 1, provides placing and fulfillment of a collaborative order for the commodity, which may reduce the number of orders to be processed on the trading platform and in turn, may increase the processing efficiency of the trading platform. Further, contents such as the commodity information shared by the subscriber may be sent to targeted users. A targeted user, compared to a generic user, generally is, more likely to be interested in the shared commodity information and may be more likely to trade the commodity, such as by purchasing it.

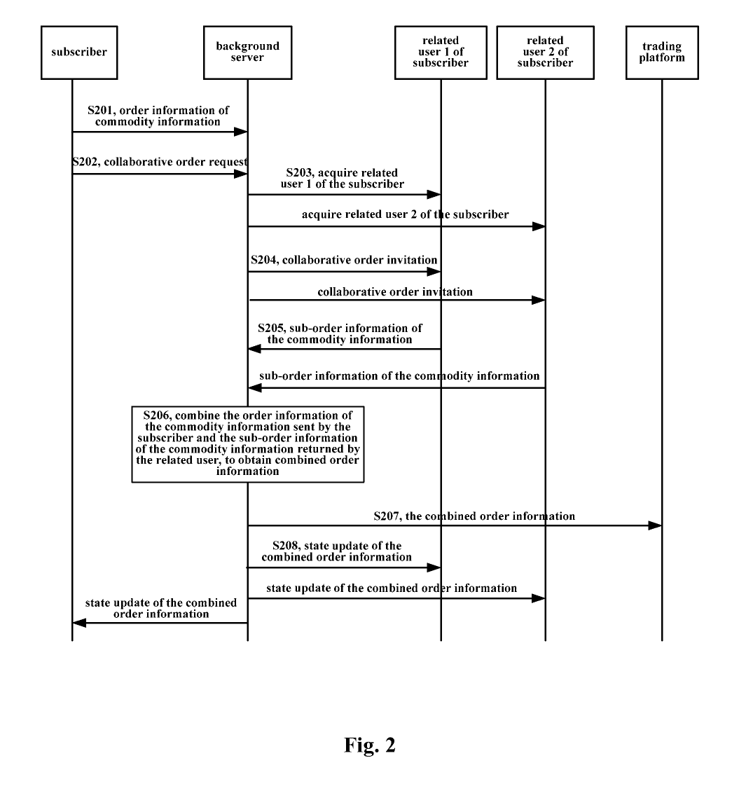

FIG. 2 illustrates a flowchart of another example method for collaborative order provided by an embodiment of the present disclosure. The method for collaborative order shown in FIG. 2 is described from the perspective of a background server computer. As shown in FIG. 2, the method for collaborative order may include the following steps.

Step S201: the background server may receive order information of a commodity. The order may be sent by a subscriber.

Step S202: the background server computer may receive a collaborative order request sent by the subscriber.

Step S203: the background server computer may determine users related to the subscriber, such as users 1 and 2. The background server computer may determine the related users of the subscriber from a related user set of the subscriber. The background server computer may determine the related users in response to the collaborative order request.

The process of determining the related users of the subscriber from the related user set of the subscriber is described in the above embodiment, and the detailed description is omitted herein.

Step S204: the background server may send a collaborative order invitation with the commodity information to the related users, such as users 1 and 2.

Step S205: the background server may receive sub-order information of the commodity sent by the related users of the subscriber. The sub-order information may be sent by the related users in responses to the collaborative order invitation.

Step S206: the background server may combine the order information of the commodity sent by the subscriber and the sub-order information of the commodity returned by the related users, to obtain, or generate combined order information.

Step S207: the background server may send the combined order information to the trading platform of the commodity for processing.

Step S208: the background server may update the state of the combined order information, and may send the combined order information with the updated state to the subscriber and the related users who returned the sub-order information of the commodity.

For example, the background server may update the state of the combined order information, and send the combined order information with the updated state to the subscriber and the related users via a message, such as a message via an instant messenger tool. The update may be in a form of an image or text, or both.

The background server may update the state of the combined order information periodically and send the combined order information with the updated state to the subscriber and the related users, until the trade of the combined order completes. For example, the background server may provide the update to users 1 and 2, who are related the subscriber, and who return the sub-order information of the commodity.

By Step S208, the subscriber may not only obtain the combined order information with the updated state, but also learn that the related users, such as users 1 and 2, are participating, or participated, in the order of the commodity. Such information may insprit, or encourage, the subscriber to initiate collaborative order request in the future, thus increasing the trading volume.

The method illustrated in FIG. 2, enables the collaborative order of the commodity to be placed and realized. The collaborative order reduces the number of orders to be processed on the trading platform and increases the processing efficiency of the trading platform. In addition, contents such as the commodity information shared by the subscriber can be sent to target users, which results in a high hit rate; and the purchasing result of the targeted users is fed back immediately.

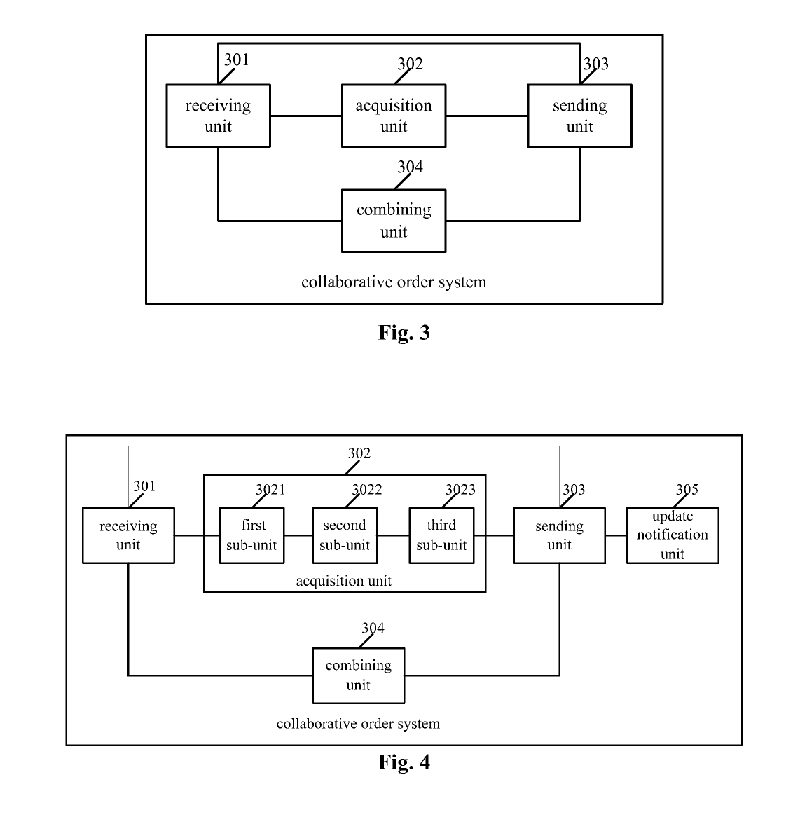

FIG. 3 illustrates a structure diagram of an example device for collaborative order provided by an embodiment of the present disclosure. The device for collaborative order provided by the embodiment of the present disclosure may be an independent device or a part of a background server, and may implement a method for placing a collaborative order. The device may include electronic circuitry for performing various functions, and as shown in FIG. 3, the circuitry may include a receiving unit 301, an acquisition unit 302, a sending unit 303 and a combining unit 304.

The receiving unit 301 may receive a collaborative order request sent by a subscriber. The collaborative order request may be for a commodity posted for trade on a trading platform, such as a web portal. The collaborative order request may contain commodity information, for identification of the commodity, such as a link to the commodity on the trading platform.

The acquisition unit 302 may obtain, in response to the collaborative order request, a related user of the subscriber from a set of users related to the subscriber.

The sending unit 303 may send a collaborative order invitation of the commodity to the related user. The collaborative order invitation may invite the user related to the subscriber to send sub-order information of the commodity in response to the collaborative order invitation.

The combining unit 304 may receive the order information of the commodity information sent by the subscriber and the sub-order information of the commodity sent by the related user of the subscriber. The combining unit 304 may combine the order information and the sub-order information of the commodity from the subscriber and the related user, respectively, to obtain combined order information.

The sending unit 303 may further send the combined order information to the trading platform of the commodity for processing.

FIG. 4 illustrates a structure diagram of another example device for collaborative order. The device shown in FIG. 4 may further optimize the device for collaborative order shown in FIG. 3. In the device shown in FIG. 4, the acquisition unit 302 may further include a first sub-unit 3021, a second sub-unit 3022, and a third sub-unit 3023.

The first sub-unit 3021, in response to the collaborative order request, may select some or all of related users of the subscriber from a set of users related to the subscriber.

The second sub-unit 3022, may generate a related user list of the subscriber based on the selected related users of the subscriber.

The third sub-unit 3023, may send the related user list of the subscriber to the subscriber and receive, in response, selection of one or more related users selected by the subscriber from the related user list. The selection may be sent by the subscriber.

The device for collaborative order shown in FIG. 4 may further include an update notification unit 305.

The update notification unit 305 may update the state of the combined order information and send the combined order information with the updated state to the subscriber and the related user who returned the sub-order information of the commodity.

The update notification unit 305 may send the combined order information with the updated state to the subscriber and the related user via a message channel, such as an instant messenger tool in a form of image or text.

The related user of the subscriber may include any one or more of a friend user of the subscriber, such as a contact listed in a contact list of the subscriber, for example a contact list of a messaging tool, or a social networking platform (such as QZone, Facebook, Google+, RenRen) used by the subscriber. Another example of the related user may be a follower user who may be following information of the commodity on the trading platform, or a user who has ordered a commodity on the trading platform. The follower user may customize his/her preferences to follow the information for the particular commodity via networking services such as Twitter, Pinterest or any other such services.

The exemplary devices for collaborative order illustrated in FIG. 3 and FIG. 4 may be provided at the subscriber side. For example, the device for collaborative order described with FIG. 3 and FIG. 4 may be implemented by updating circuitry, and a program of a local terminal of the subscriber, which is not limited herein.

The exemplary device for collaborative order illustrated in FIG. 3 and FIG. 4 may realize the collaborative order of the commodity, and in turn, reduce the number of orders to be processed on the trading platform, thus increasing the processing efficiency of the trading platform. In addition, contents such as the commodity information shared by the subscriber may be sent to targeted users, which results in a high hit rate, and the purchasing result of the targeted users is fed back immediately.

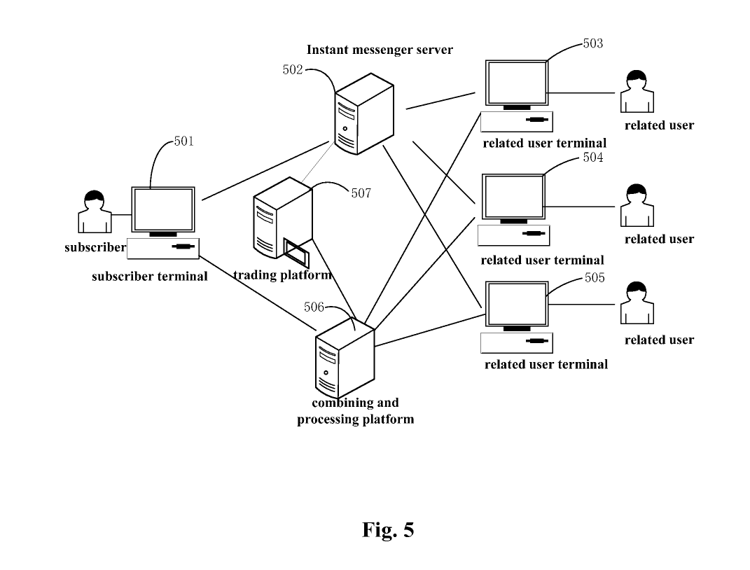

FIG. 5 illustrates a structure diagram of an example system for collaborative order. The example system for collaborative order shown in FIG. 5 includes a subscriber terminal 501, an instant messenger server 502, related user terminals 503-505, a combining and processing platform 506 and a trading platform 507.

The subscriber terminal 501 may receive a collaborative order request input by a subscriber and send the collaborative order request to the instant messenger server 502. The collaborative order request may carry commodity information.

The instant messenger server 502 may receive the collaborative order request sent by the subscriber terminal 501, and in response, determine related user terminals 503-505 corresponding to the subscriber. The related user terminals 503-505 may be determined from a related user set of the subscriber. The instant messenger server 502 may further send a collaborative order invitation containing the commodity information to the related user terminals 503-505.

The related user terminals 503-505, in response to the collaborative order invitation, may send sub-order information of the commodity to the combining and processing platform 506. The sub-order may contain the commodity information.

The subscriber terminal 501 may further receive order information of the commodity input by the subscriber and send the order information to the combining and processing platform 506.

The combining and processing platform 506 may receive the order information of the commodity sent by the subscriber terminal 501 and the sub-order information of the commodity sent by the related user terminals 503-505. The combining and processing platform 506 may combine the order information and the sub-order information to obtain combined order information of the commodity. The combining and processing platform 506 may further send the combined order information to the trading platform 507.

The trading platform 507 may receive the combined order information for processing the collaborative order for the commodity.

The combining and processing platform 506 may be an independent device, or may be integrated in the instant messenger sever 502 or the trading platform 507. Placement, or location of the combining and processing platform 506 does not limit the embodiments described throughout the present disclosure.

The subscriber terminal 501 and the related user terminals 503-505 may be computers, smart phones, tablet PCs and other Mobile Internet Devices (MIDs), or any other devices involving circuitry such as processors, memory, co-processors, and other such devices.

The instant messenger server 502 may acquire, or determine, one or more related users of the subscriber from a related user set of the subscriber in response to the collaborative order request as described further. The instant messenger server 502 may be a server computer, or a collection of server computers collectively operating as a single server.

The instant messenger server 502, in response to the collaborative order request, may select some or all of related users of the subscriber from the related user set of the subscriber. The instant messenger server 502 may further generate a list of related users of the subscriber based on related users selected. The instant messenger server 502 may further send the list of selected related users of the subscriber to the subscriber terminal 501. Further yet, the instant messenger server 502 may receive a related user further selected, by the subscriber, from the list of selected related users. The subscriber terminal 501 may send the list of selected related users containing representation of a further selection of the related users, the further selection independently performed by the subscriber indicating the related users who may participate in the collaborative order.

The instant messenger server 502 may further update the state of the combined order information and send the combined order information with the updated state to the subscriber terminal 501 and the relational user terminals 503-505. The instant messenger server 502 may selectively send the updated state to the subscriber and the related users that placed the order and/or the sub-order for the commodity.

The instant messenger server 502 may send the combined order information with the updated state to the subscriber terminal 501 and the relational user terminals 503-505 as described further.

The instant messenger server 502 may update the state of the combined order information. The instant messenger server 502 may send the combined order information with the updated state to the subscriber terminal 501 that initiated the commodity order. The instant messenger server 502 may also send the combined order information with the updated state to the related user terminals 503-505 that were used to place a sub-order, that is part of the collaborative order. The combined order information with the updated state of the commodity may be sent by the instant messenger server 502 via a message channel, such as a message channel of an instant messenger tool in a form of image or text.

The related user of the subscriber may include a user that may be linked, or associated with the subscriber. For example, the related user may be a user connected with the subscriber via the network, such as a friend user of the subscriber in an address book such as that of an instant messenger, or a social network connection of the subscriber. Further, the related used may be a ‘follower’ user who is following the commodity information on the trading platform, or a user who has ordered a commodity on the trading platform. The follower user may have customized his/her preferences on a microblogging service to follow the information relevant to the commodity on the trading platform. Additionally, or alternatively, the related user may be following the subscriber via a microblogging service.

The system for collaborative order described with FIG. 5 may realize collaborative order for a commodity, as described throughout the present disclosure. The collaborative order may reduce the number of orders to be processed on the trading platform and thus, increase the processing efficiency of the trading platform. In addition, contents such as the commodity information shared by the subscriber can be sent to targeted users, which results in a high hit rate, and the purchasing result of the targeted users is fed back immediately. Hit rate may indicate a number of clicks or views of the commodity on the trading platform. The hit rate may also include number of purchases of the commodity on the trading platform.

Those skilled in the art may understand that part or all of the steps of the method according to the above embodiments may be implemented by electronic circuitry and hardware instructed by a program. The program may be stored in a computer readable storage medium, and the storage medium may include, for example, flash disk, read-only memory (ROM), random access memory (RAM), disk and CD.

The method, device and system for collaborative order according to the embodiments of the present disclosure have been described in detail above. Examples are used to explain the principle and implementation of the disclosure herein. The description of the embodiments is only used to facilitate understanding the technical solutions of the disclosure and some of the various possible ways to put the technical solutions in practice. The embodiments and the application scope may be changed by those skilled in the art based on the present disclosure. Therefore, the description of the examples should not be considered as limitation of the present disclosure.

1. A method for processing a collaborative order, comprising:
receiving a collaborative order request sent by a subscriber, wherein the collaborative order request contains information about a commodity;
determining, in response to the collaborative order request, a user related to the subscriber, from a related user set of the subscriber in response to the collaborative order request;
sending a collaborative order invitation with the commodity information to the related user, to invite the related user to send sub-order information of the commodity in response to the collaborative order invitation;
receiving order information of the commodity sent by the subscriber and the sub-order information of the commodity sent by the related user;
combining the order information and the sub-order information of the commodity; and
sending the combined order information to a trading platform of the commodity for processing.

2. The method according to claim 1, wherein the determination of the related user of the subscriber from the related user set of the subscriber in response to the collaborative order request comprises:
selecting one or more related users from the related user set of the subscriber in response to the collaborative order request;
generating a related user list corresponding to the subscriber based on the selected one or more related users of the subscriber;
sending the related user list to the subscriber; and
receiving the related user of the subscriber selected by the subscriber from the related user list.

3. The method according to claim 1, wherein the method further comprises:
updating a state of the combined order information; and
sending to the subscriber and the related user of the subscriber who sent the sub-order information, the combined order information with the updated state.

4. The method according to claim 2, further comprising:
updating a state of the combined order information; and
sending the combined order information with the updated state to the subscriber and the related user of the subscriber who sent the sub-order information.

5. The method according to claim 3, wherein the combined order information with the updated state is sent to the subscriber and the related user of the subscriber via a message channel of an instant messenger tool in a form of image or text.

6. The method according to claim 1, wherein the related user of the subscriber comprises a friend user of the subscriber connected to the subscriber via an electronic communication medium, a user connected to the subscriber via a social networking platform, a follower user following the commodity information on the trading platform, and a user who has ordered another commodity on the trading platform.

7. The method according to claim 2, wherein the related user of the subscriber comprises a friend user of the subscriber connected to the subscriber via an electronic communication medium, a user connected to the subscriber via a social networking platform, a user following the commodity information on the trading platform, and a user who has ordered another commodity on the trading platform of the commodity information.

8. A device for processing a collaborative order, comprising circuitry for a receiving unit, an acquisition unit, a sending unit and a combining unit, wherein,
the receiving unit is configured to receive a collaborative order request sent by a subscriber, wherein the collaborative order request carries commodity information;
the acquisition unit is configured to acquire a related user of the subscriber from a set of users related to the subscriber in response to the collaborative order request;
the sending unit is configured to invite the related user to send sub-order information of the commodity information by transmission of a collaborative order invitation of the commodity information to the related user;
the combining unit is configured to receive order information of the commodity information sent by the subscriber and the sub-order information of the commodity information sent by the related user, and combine the order information and the sub-order information to obtain combined order information; and
the sending unit is further configured to send the combined order information to a trading platform of the commodity information.

9. The device according to claim 8, wherein the acquisition unit comprises:
a first sub-unit, configured to select one or more related users from the set of users related to the subscriber in response to the collaborative order request;
a second sub-unit, configured to generate a related user list based on the selected one or more related users; and
a third sub-unit, configured to send the related user list to the subscriber, and receive a related user selected by the subscriber from the related user list of the subscriber.

10. The device according to claim 8, wherein the circuitry further comprises an update notification unit, wherein,
the update notification unit is configured to update a state of the combined order information and send the combined order information with the updated state to the subscriber and the related user who sent the sub-order information.

11. The device according to claim 9, wherein the circuitry further comprises an update notification unit, wherein
the update notification unit is configured to update a state of the combined order information and send the combined order information with the updated state to the subscriber and the related user who sent the sub-order information.

12. The device according to claim 10, wherein the update notification unit is configured to send the combined order information with the updated state to the subscriber and the related user via a message channel of an instant messenger tool in a form of image or text.

13. The device according to claim 8, wherein the related user of the subscriber comprises a user listed in a contact list of the subscriber, a user connected to the subscriber via a social networking platform, a user following the commodity information on the trading platform, and a user who has ordered another commodity on the trading platform.

14. The device according to claim 9, wherein the related user of the subscriber comprises a user listed in a contact list of the subscriber, a user connected to the subscriber via a social networking platform, a user following the commodity information on the trading platform, and a user who has ordered another commodity on the trading platform.

15. A system for collaborative order, comprising a subscriber terminal, an instant messenger server computer, a related user terminal, a combining and processing platform and a trading platform, wherein
the subscriber terminal is configured to receive a collaborative order request input by a subscriber and send the collaborative order request to the instant messenger server computer, wherein the collaborative order request contains commodity information;
the instant messenger server computer is configured to receive the collaborative order request sent by the subscriber terminal, and in response to the collaborative order request, determine the related user terminal corresponding to a related user of the subscriber, wherein the related user is one from a set of users related to the subscriber, and the instant messenger server computer is further configured send a collaborative order invitation of the commodity information to the related user terminal;
the related user terminal is configured to send sub-order information of the commodity information to the combining and processing platform in response to the collaborative order invitation;
the subscriber terminal is further configured to receive order information of the commodity information that is input by the subscriber and send the order information of the commodity information to the combining and processing platform;
the combining and processing platform is configured to receive the order information of the commodity information sent by the subscriber terminal and the sub-order information of the commodity information sent by the related user terminal, combine the order information and the sub-order information to obtain combined order information, and further send the combined order information to the trading platform; and
the trading platform is configured to receive the combined order information.

16. The system according to claim 15, wherein, the instant messenger server computer is further configured to:
in response to the collaborative order request, select one or more of the related users from the set of users related to the subscriber,
generate a related user list based on the selected one or more related users,
send the related user list to the subscriber terminal, and
receive identity of the related user of the subscriber, the related user is selected by the subscriber from the related user list and the identity of the related user sent by the subscriber terminal.

17. The system according to claim 15, wherein the instant messenger server computer is further configured to update a state of the combined order information, and send the combined order information with the updated state to the subscriber terminal and the related user terminal that sent the sub-order information.

18. The system according to claim 16, wherein the instant messenger server computer is further configured to update a state of the combined order information, and send the combined order information with the updated state to the subscriber terminal and the related user terminal of the subscriber that sent the sub-order information.

19. The system according to claim 17, wherein the instant messenger sever computer is configured to send the combined order information with the updated state to the subscriber terminal and the related user terminal via a message channel of an instant messenger tool in a form of image or text.

20. The system according to claim 15, wherein the relational user of the subscriber comprises a user listed in a contact list of the subscriber, a user connected to the subscriber via a social networking platform, a user following the commodity information on the trading platform, and a user who has ordered another commodity on the trading platform.
